(19) United States
(12) Patent Application Publication
(10) Pub. No.: US 2005/0103536 A1
(43) Pub. Date: May 19, 2005

(54) Virtual input using a pen

(75) Inventor: Fritz Seytter, Muenchen (DE)

Correspondence Address: BELL, BOYD & LLOYD, LLC, P. O. BOX 1135, CHICAGO, IL, 60690-1135, US

(73) Assignee: Siemens Aktiengesellschaft, Muenchen (DE)

(21) Appl. No.: 10/496,682

(22) PCT Filed: Nov. 4, 2002
(86) PCT No.: PCT/EP02/12294

(30) Foreign Application Priority Data
Nov. 26, 2001 (EP) 01128037.7

(51) Int. Cl. G06K 11/06; G08C 21/00

(52) U.S. Cl. 178/18.01

(57) ABSTRACT

The invention relates to a method for inputting information using a pen on a surface (SO). According to said method, the displacement path of a pen (ST) is represented in graphic form on a transparent display or a transparent microdisplay (MD), whereby means allowing the pen (ST) and the graphics on the display (MD) to be locally coupled are provided.

The invention relates to a method for inputting information using a pen on a surface. According to said method, the displacement path of the pen is represented in graphic form on a display.

In miniaturized data terminals, in spite of small, inconspicuous and lightweight devices, there is a requirement for a large graphics screen. Furthermore, the user wishes to be able to input data in as natural a manner as possible. Future data terminals might therefore be equipped with a transparent microdisplay in which graphic information is projected via the natural environment. Such microdisplays are provided, for example, by “The MicroDisplay Corporation”. Inputting graphics using a pen is difficult on such a projected screen.

Technologies for inputting information using a pen on any surface are known, according to which, on the one hand, active pens with built-in displacement detection (cf. for example, www.anoto.com or www.com.n.com) are used, or according to which, on the other hand, by means of direction-finding technologies (cf. for example, www.virtual-ink.com), position recognition of a passive pen takes place relative to a data entry terminal. In these active as well as passive pens, data is transferred, for example, to a notebook, on which the displacement path is represented in graphic form, for example, by a line.

The object of the invention is to indicate a method for inputting information using a pen, in particular for a transparent microdisplay which enables natural handling for the user.

This object is achieved according to the invention by the features indicated in the claim.

An advantage of the method according to the invention is that other people cannot observe or hear inputting.

In the following the invention is described on the basis of an exemplary embodiment shown in the drawing.

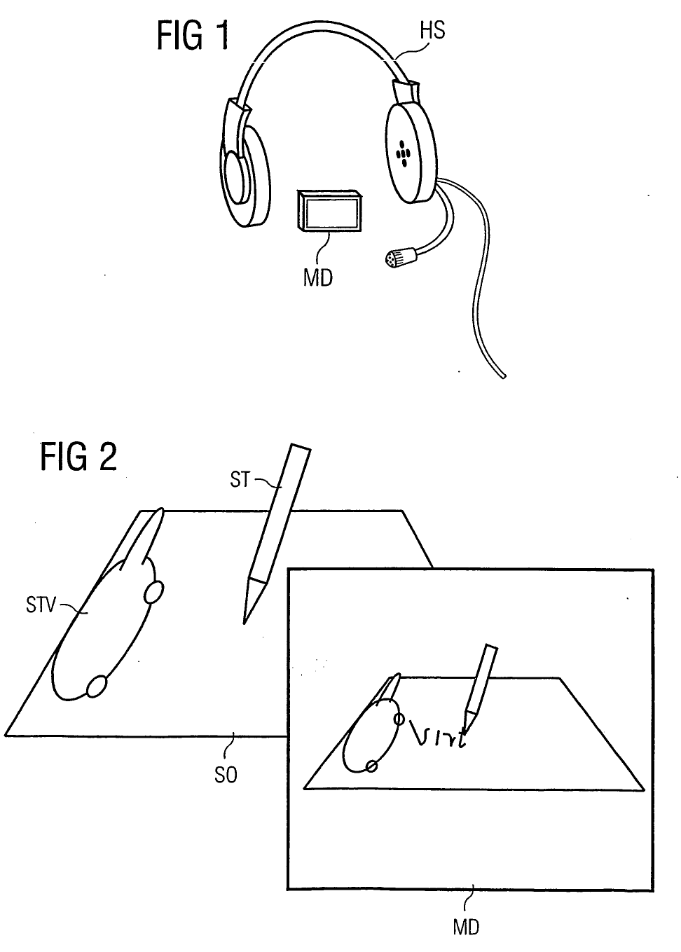

FIG. 1 shows the use of a microdisplay in connection with a headset, and

FIG. 2 the method according to the invention for inputting information using a pen.

The method according to the invention for inputting information using a pen permits the evaluated movement or displacement path of the pen to be represented in such a way on a transparent microdisplay that the visual impression arises that the pen is actually writing. In actual fact the pen moves on the respective support or surface without leaving a trace there. The displacement path so to speak is represented by a so-called “virtual ink” which flows from the tip of the pen as in the case of a real ballpoint pen.

In FIG. 1 a microdisplay MD is represented which, for example, is attached to a headset HS. If the microdisplay MD is embodied as a transparent microdisplay, then the user of the headset HS sees the diagram projected or represented on the microdisplay MD via the real background in front of him. For example, the user sees a text inserted on the display MD projected over the natural background.

In FIG. 2 a writing surface SO is represented on which there is a pen tracer STV which records the displacement of a pen ST. The writing surface SO forms the acquisition area so to speak on which the displacement path of the pen ST can be evaluated.

In the method according to the invention, means are provided allowing the pen ST and the graphics created by it to be locally coupled in the transparent microdisplay MD.

On the transparent display or transparent microdisplay MD, the graphics input using the pen ST is represented. Care should be taken here that the graphics appear as a projection on the microdisplay MD, while these graphics are not discernible on the real writing surface SO. Only the user or the observer who sees the whole scenario, in other words, projection image on the microdisplay MD and the real pen ST, sees so to speak a writing pen which leaves a virtual trail of ink behind it.

The object of the invention is to make the detected displacement of the pen visible on the microdisplay MD in such a way that the virtual impression arises that the pen is writing, although it is moving on the support without leaving a trace.

To achieve the object of the invention, the microdisplay MD coupled to the eye in its displacement is calibrated by means of the user, for example, touching one or more visible points on the display MD. This touching naturally occurs with the pen ST on the writing surface SO, in other words on the projection of the points on the writing surface SO. Compensation of the head displacement has the effect then of making the virtual writing or also line drawing remain at the same place on the writing surface SO for the user, who sees the writing surface SO via the microdisplay MD, while he is able to continue writing or drawing, and the virtual ink flows on from the tip of the pen ST.

In the display MD the user sees a combination of the real pen and the virtual ink which are locally coupled. Hereby the impression arises of a writing pen ST.

An external observer can only follow the movement of the pen, but would not see either the emerging graphics or writing, or a drawing that arises.

1. Method for inputting information using a pen on a surface (SO),
whereby the displacement path of a pen (ST) is represented in graphic form on a transparent display or transparent microdisplay (MD), and
whereby means are provided allowing the pen (ST) and the graphics on the display (MD) to be locally coupled.
